(19) United States
(12) Patent Application Publication
(10) Pub. No.: US 2006/0199875 A1
(43) Pub. Date: Sep. 7, 2006

(54) Photo-curable resin composition

(75) Inventors: Hideki Kitano, Tokyo (JP); Masami Aoki, Tokyo (JP); Takahiro Matsuse, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 11/365,839

(22) Filed: Mar. 2, 2006

(30) Foreign Application Priority Data
Mar. 2, 2005 (JP) 058120/2005
Jan. 27, 2006 (JP) 2006/018930

(51) Int. Cl. C08J 3/28

(52) U.S. Cl. 522/160

(57) ABSTRACT

A photo-curable resin composition includes a photo-acid generator, a dye having an absorption in a range of 760 to 2,000 nm, and a cationic photopolymerizable composition, wherein the photo-acid generator generates an acid by irradiation of near-infrared light to initiate cationic polymerization reaction for curing. Alternatively, a photo-curable resin composition includes a radical generator, a dye having an absorption in a range of 760 to 2,000 nm, and a radical photopolymerizable composition, wherein radical polymerization reaction is initiated by irradiation of near-infrared light to perform curing.

### BACKGROUND OF THE INVENTION

1. Field of the Invention

The present invention relates to a photo-curable resin composition (hereinafter, may also be simply referred to as “resin composition”), and more particularly, relates to a near-infrared curable resin composition which can be polymerized and cured by irradiation of near-infrared light in a wavelength range of about 760 to 2,000 nm.

2. Description of the Related Art

In view of low-polluting, resource-saving materials, in recent years, technologies regarding photo-curable resin compositions have been advancing, which have been effective in use of less solvent, decrease in volatile organic compound (VOC) emissions, stability of one-component liquid, improvement in work efficiency due to fast curability, etc. Meanwhile, most of the photo-curable resin compositions currently proposed and put in practical use are cured by irradiation with ultraviolet light. Such ultraviolet-curable resin compositions are used in various fields, for example, as described in Japanese Unexamined Patent Application Publication No. 2001-172380.

The ultraviolet-curable resin compositions, although advantageous in that short-time curing is enabled, are disadvantageous in that irradiation apparatuses are expensive, light sources are hazardous to human body, etc. Under these circumstances, recently, research has been actively carried out on photo-curable resin compositions using light in the visible range. In the case of visible light, a darkroom is needed to produce materials, and the pot life, use environment, and others are greatly limited.

Furthermore, photo-curable resin compositions are cured when irradiated with light with a predetermined wavelength that excites a photopolymerization initiator. It is difficult to cure portions where light does not reach. Consequently, examples of conventionally known photo-curable resin compositions include those which can transmit light to the inside of the resins and those which contain a small amount of an additive, such as an extender pigment, and a transparent resin and have low hiding power. However, since it is difficult to completely cure materials containing color pigments or the like that opacify resin compositions themselves, photo-curable resin compositions having high hiding power are not used. Therefore, the conventional photo-curable resin compositions have not been substantially used in the applications that require complete opaqueness.

### SUMMARY OF THE INVENTION

The fact that photo-curable resin compositions hide light means that even in the case of visible light, light is not transmitted to the inside of the resin compositions. Therefore, even if ultraviolet light is used, it is difficult to allow light to be transmitted to the inside of an opaque resin composition layer having a thickness exceeding the thickness that exhibits hiding power. If light energy is increased by increasing the irradiation time or the like, curing can be performed inside the layer to a certain degree even in colored materials. However, in such a case, the thickness of the resin layer that can be cured is still limited. Moreover, the surface of the cured layer is overcured and internal stress increases, which may cause various problems.

Accordingly, it is an object of the present invention to provide a photo-curable resin composition which can be cured reliably even if the composition includes portions having high hiding power to a certain degree because of use of a coloring agent or the like.

As a result of intensive research, the present inventors have found that by using a dye having an absorption in a predetermined wavelength range, curing can be performed with near-infrared light to overcome the problems described above. Thus, the present invention has been achieved.

A first photo-curable resin composition of the present invention includes a photo-acid generator, a dye having an absorption in a range of 760 to 2,000 nm, and a cationic photopolymerizable composition, wherein the photo-acid generator generates an acid by irradiation of near-infrared light to initiate cationic polymerization reaction for curing.

In the first photo-curable resin composition of the present invention, preferably, the photo-acid generator generates a Broensted acid or a Lewis acid by the irradiation of near-infrared light, and also preferably, the photo-acid generator is at least one selected from the group consisting of aryldiazonium salts, diaryliodonium salts, triarylsulfonium salts, dialkylphenacylsulfonium salts, and sulfonic ester compounds.

A second photo-curable resin composition of the present invention includes a radical generator, a dye having an absorption in a range of 760 to 2,000 nm, and a radical photopolymerizable composition, wherein radical polymerization reaction is initiated by irradiation of near-infrared light to perform curing.

In the second photo-curable resin composition of the present invention, preferably, the radical generator is at least one selected from the group consisting of organic peroxides, bisimidazole, iodonium salts, polyhalides, titanocene, boron compounds, sulfonic acid derivatives, and N-phenylglycine. Preferably, the second photo-curable resin composition of the present invention includes a radical polymerizable compound containing at least one ethylenically unsaturated double bond.

Preferably, the photo-curable resin composition of the present invention further includes an ultraviolet-curable resin composition component which is cured by irradiation of ultraviolet light. More preferably, the refractive index of the component cured by the irradiation of near-infrared light is higher than the refractive index of the component cured by the irradiation of ultraviolet light. In such a case, more preferably, the dye is decomposed by the irradiation of ultraviolet light and the absorption in the near-infrared range is decreased. Furthermore, preferably, the photo-curable resin composition of the present invention further includes a thermosetting resin composition component that is cured by heating.

The photo-curable resin compositions of the present invention can be suitably used for optical parts and optical waveguides.

In the photo-curable resin compositions of the present invention, near-infrared light in a wavelength range of about 760 to 2,000 nm can be used as light for curing. Consequently, even in the case in which the compositions have opaque portions having high hiding power to a certain degree, curing can be performed reliably. Furthermore, the present invention is advantageous in that the resin compositions can be cured even by light in the infrared wavelength range which has lower energy than light in the ultraviolet range and which is also used for communication. Furthermore, for example, in comparison with light in the ultraviolet range, the light in the near-infrared range used for curing has less adverse effect on human body and higher safety. Thick films and large areas can also be cured. Moreover, in curing in the ultraviolet range, resin compositions are affected by white light. In contrast, in curing in the near-infrared range, resin compositions are less affected by white light, and good handling properties are exhibited.

### DESCRIPTION OF THE PREFERRED EMBODIMENTS

Preferred embodiments of the present invention will be described in detail below.

A first photo-curable resin composition of the present invention includes a photo-acid generator, a dye having an absorption in a range of 760 to 2,000 nm, and a cationic photopolymerizable composition. The photo-acid generator generates an acid by irradiation of near-infrared light to initiate cationic polymerization reaction for curing. In this case, electron transfer occurs between the dye which has absorbed near-infrared light and the photo-acid generator, and the photo-acid generator generates the acid.

Examples of the dye having an absorption in a range of 760 to 2,000 nm and which may be used in the present invention include, but are not limited to, pyrylium dyes, thiopyrylium dyes, cyanine dyes, indolium dyes, and triazine dyes. Specific examples thereof include 2-[7-(1,3-dihydro-1,1,3-trimethyl-2H-benzindol-2-ylidene)-1,3,5-heptatrienyl]-1,1,3-trimethyl-1H-benzindolium perchlorate, 3-ethyl-2-[2-[3-[2-(3-ethyl-2(3H)-benzothiazolylidene)ethylidene]-2-diphenylamino-1-cyclopentan-1-yl]ethenyl]benzothiazolium perchlorate, 1-ethyl-2-[7-(1-ethyl-2(1H)-quinolidene)-1,3,5-heptatrienyl]quinolium iodide, 8-[(6,7-dihydro-2,4-diphenyl-5H-1-benzopyran-8-yl)methylene]5,6,7,8-tetrahydro-2,4-diphenyl-1-benzopyrylium perchlorate, nickel bis(dithiobenzyl), nickel bis[2′-chloro-3-methoxy-4-(2-methoxyethoxy)dithiobenzyl], 1-ethyl-4-[7-(ethyl-4(1H)-quinolylidene)-1,3,5-heptatrienyl]quinolium iodide, 4-4′-[3-2-(1-ethyl-4(1H)-quinolinylidene)ethylidene]propenylene]bis(1-ethylquinolium iodide), and dyes produced by Hayashibara Biochemical Labs., inc., such as NK-4432, NK-4680, NK-5557, NK-5559, NK-5911, NK-2882, NK-4489, NK-4474, NK-5020, NK-2014, and NK-2912. In the resin composition of the present invention, the dye can be used usually in an amount of 0.1% to 20% by mass, and preferably about 1% to 10% by mass.

Examples of the photo-acid generator include 1,2-naphthoquinone-2-diazide-5-sulfonyl chloride, sodium 1,2-naphthoquinone-2-diazide-5-sulfonate, potassium 1,2-naphthoquinone-2-diazide-5-sulfonate, methyl 1,2-naphthoquinone-2-diazide-5-sulfonate, ethyl 1,2-naphthoquinone-2-diazide-5-sulfonate, capryl 1,2-naphthoquinone-2-diazide-5-sulfonate, and cetyl 1,2-naphthoquinone-2-diazide-5-sulfonate; 1,2-naphthoquinone-2-diazide-4-sulfonyl chloride, sodium 1,2-naphthoquinone-2-diazide-4-sulfonate, potassium 1,2-naphthoquinone-2-diazide-4-sulfonate, methyl 1,2-naphthoquinone-2-diazide-4-sulfonate, ethyl 1,2-naphthoquinone-2-diazide-4-sulfonate, hexyl 1,2-naphthoquinone-2-diazide-5-sulfonate, lauroyl 1,2-naphthoquinone-2-diazide-5-sulfonate, and stearyl 1,2-naphthoquinone-2-diazide-5-sulfonate; 1,2-benzoquinone-2-diazide-4-sulfonyl chloride, sodium 1,2-benzoquinone-2-diazide-4-sulfonate, potassium 1,2-benzoquinone-2-diazide-4-sulfonate, methyl 1,2-benzoquinone-2-diazide-4-sulfonate, ethyl 1,2-benzoquinone-2-diazide-4-sulfonate, caproyl 1,2-benzoquinone-2-diazide-4-sulfonate, decyl 1,2-benzoquinone-2-diazide-4-sulfonate, stearyl 1,2-benzoquinone-2-diazide-4-sulfonate, and 1,2-benzoquinone-2-diazide.

Other examples of the photo-acid generator which may be used are condensates of an aliphatic diol, such as ethylene glycol, 1,3-propanediol, 1,6-hexanediol, 1,10-decanediol, or 1,16-hexadecanediol, with 1,2-naphthoquinone-2-diazide-4 (or -5)-sulfonyl chloride; condensates of a hydroxylated aromatic compound, such as phenol, hydroquinone, catechol, resorcinol, or pyrogallol, with 1,2-naphthoquinone-2-diazide-4 (or -5)-sulfonyl chloride; and condensates of a polyhydroxybenzophenone, such as 2,3,4-trihydroxybenzophenone, 2,2′,4,4′-tetrahydroxybenzophenone, or 2,2′,3,4,4′-pentahydroxybenzophenone, with 1,2-naphthoquinone-2-diazide-4(or -5)-sulfonyl chloride. Specific examples thereof include trihydoxybenzophenone di(1,2-naphthoquinone-2-diazide-4-sulfonic acid) ester, trihydoxybenzophenone tri(1,2-naphthoquinone-2-diazide-4-sulfonic acid) ester, tetrahydroxybenzophenone di(1,2-naphthoquinone-2-diazide-4-sulfonic acid) ester, tetrahydroxybenzophenone tri(1,2-naphthoquinone-2-diazide-4-sulfonic acid) ester, tetrahydroxybenzophenone tetra(1,2-naphthoquinone-2-diazide-4-sulfonic acid) ester, trihydoxybenzophenone di(1,2-naphthoquinone-2-diazide-5-sulfonic acid) ester, trihydroxybenzophenone tri(1,2-naphthoquinone-2-diazide-5-sulfonic acid) ester, tetrahydroxybenzophenone di(1,2-naphthoquinone-2-diazide-5-sulfonic acid) ester, tetrahydroxybenzophenone tri(1,2-naphthoquinone-2-diazide-5-sulfonic acid) ester, and tetrahydroxybenzophenone tetra(1,2-naphthoquinone-2-diazide-5-sulfonic acid) ester; 2-diazo-5,5-dimethyl-cyclohexane-1,3-dione, and 2,2-dimethyl-5-diazide-4,6-diketo-1,3-dioxane.

In particular, preferably, at least one photo-acid generator selected from the group consisting of aryldiazonium salts, diaryliodonium salts, triarylsulfonium salts, dialkylphenacylsulfonium salts, and sulfonic ester compounds is used. Furthermore, a photo-acid generator that generates a Broensted acid or a Lewis acid by the irradiation of near-infrared light is preferably used. In the resin composition of the present invention, the photo-acid generator can be used usually in an amount of 0.1% to 20% by mass, and preferably about 1 to 10% by mass.

As the cationic photopolymerizable composition, for example, a polymerizable monomer having one oxetane ring may be used. Specific examples thereof include 3-ethyl-3-hydroxymethyloxetane, 3-(meth)allyloxymethyl-3-ethyloxetane, (3-ethyl-3-oxetanylmethoxy)methylbenzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl) ether, isobornyloxyethyl(3-ethyl-3-oxetanylmethyl) ether, isobornyl(3-ethyl-3-oxetanylmethyl) ether, 2-ethylhexyl(3-ethyl-3-oxetanylmethyl) ether, ethyldiethylene glycol(3-ethyl-3-oxetanylmethyl) ether, dicyclopentadiene(3-ethyl-3-oxetanylmethyl) ether, dicyclopentenyloxyethyl(3-ethyl-3-oxetanylmethyl) ether, dicyclopentenylethyl(3-ethyl-3-oxetanylmethyl) ether, tetrahydrofurfuryl(3-ethyl-3-oxetanylmethyl) ether, tetrabromophenyl(3-ethyl-3-oxetanylmethyl) ether, 2-tetrabromophenoxyethyl(3-ethyl-3-oxetanylmethyl) ether, tribromophenyl(3-ethyl-3-oxetanylmethyl) ether, 2-tribromophenoxyethyl(3-ethyl-3-oxetanylmethyl) ether, 2-hydroxyethyl(3-ethyl-3-oxetanylmethyl) ether, 2-hydroxypropyl(3-ethyl-3-oxetanylmethyl) ether, butoxyethyl(3-ethyl-3-oxetanylmethyl) ether, pentachlorophenyl(3-ethyl-3-oxetanylmethyl) ether, pentabromophenyl(3-ethyl-3-oxetanylmethyl) ether, and bornyl(3-ethyl-3-oxetanylmethyl) ether.

Specific examples of a polymerizable monomer having two oxetane rings include 1,4-bis{[(3-ethyl-3-oxetanyl)methoxy]methyl}benzene, bis{[(1-ethyl)3-oxetanyl]methyl} ether, 1,4-bis[(3-ethyl-3-oxetanyl)methoxy]benzene, 1,3-bis[(3-ethyl-3-oxetanyl)methoxy]benzene, 3,7-bis(3-oxetanyl)-5-oxa-nonane, 1,4-bis[(3-ethyl-3-oxetanylmethoxy)methyl]benzene, 1,2-bis[(3-ethyl-3-oxetanylmethoxy)methyl]ethane, 1,2-bis[(3-ethyl-3-oxetanylmethoxy)methyl]propane, ethylene glycol bis(3-ethyl-3-oxetanylmethyl) ether, dicyclopentenylbis(3-ethyl-3-oxetanylmethyl) ether, triethylene glycol bis(3-ethyl-3-oxetanylmethyl) ether, tetraethylene glycol bis(3-ethyl-3-oxetanylmethyl) ether, tricyclodecanediyldimethylenebis(3-ethyl-3-oxetanylmethyl) ether, 1,4-bis[(3-ethyl-3-oxetanylmethoxy)methyl]butane, 1,6-bis[(3-ethyl-3-oxetanylmethoxy)methyl]hexane, polyethylene glycol bis(3-ethyl-3-oxetanylmethyl) ether, EO modified bisphenol A bis(3-ethyl-3-oxetanylmethyl) ether, PO modified bisphenol A bis(3-ethyl-3-oxetanylmethyl) ether, EO modified hydrogenated bisphenol A bis(3-ethyl-3-oxetanylmethyl) ether, PO modified hydrogenated bisphenol A bis(3-ethyl-3-oxetanylmethyl) ether, and EO modified bisphenol F bis(3-ethyl-3-oxetanylmethyl) ether.

Specific examples of a polymerizable monomer having three to five oxetane rings include trimethylolpropane tris(3-ethyl-3-oxetanylmethyl) ether, pentaerythritol tris(3-ethyl-3-oxetanylmethyl) ether, pentaerythritol tetrakis(3-ethyl-3-oxetanylmethyl) ether, and dipentaerythritol pentakis(3-ethyl-3-oxetanylmethyl) ether.

Other examples of the cationic photopolymerizable composition that may be used are glycidyl ether-type epoxy compounds, such as di- or poly-glycidyl ethers of aromatic ring-containing polyhydric phenols or alkylene oxide adducts thereof, and di- or poly-glycidyl ethers of aliphatic polyhydric alcohols or alkylene oxide adducts thereof. Specific examples thereof include di- or poly-glycidyl ethers of bisphenol A, bisphenol F, bisphenol S, hydrogenated bisphenol A, hydrogenated bisphenol F, hydrogenated bisphenol S, bisphenol fluorene, or alkylene oxide adducts of these phenols; di-glycidyl ethers of alkylene glycols, such as ethylene glycol, propylene glycol, 1,4-butanediol, 1,6-hexanediol, or alkylene oxide adducts thereof; di-glycidyl ethers of polyalkylene glycols, such as polyethylene glycol and polypropylene glycol; di-glycidyl ethers of neopentyl glycol, dibromoneopentyl glycol, or alkylene oxide adducts of these glycols; di- or tri-glycidyl ethers of trimethylol ethane, trimethylol propane, glycerin, or alkylene oxide adducts of these trihydric alcohols; poly-glycidyl ethers of polyhydric alcohols, such as di-, tri-, or tetra-glycidyl ethers of pentaerythritol, or alkylene oxide adducts thereof; novolak-type epoxy resins; cresol novolak resins; and compounds obtained by substituting aromatic rings of these compounds with halogen atoms.

Examples of an alicyclic epoxy compound that may be used as the cationic photopolymerizable composition include cyclohexene oxide or cyclopentene oxide-containing compounds obtained by epoxidation of compounds having a cycloalkane ring, such as a cyclohexene or cyclopentene ring, with an appropriate oxidizing agent, such as hydrogen peroxide or peroxy acid. Specific examples thereof include 3,4-epoxycyclohexylmethyl-3′,4′-epoxycyclohexane carboxylate, 2-(3,4-epoxycyclohexyl-5,5-spiro-3,4-epoxy)cyclohexane-meta-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxycyclohexane), dicyclopentadiene diepoxide, di(3,4-epoxycyclohexylmethyl) ether of ethylene glycol, ethylenebis(3,4-epoxycyclohexane carboxylate), epoxidized tetrabenzyl alcohol, lactone-modified 3,4-epoxycyclohexylmethyl-3′,4′-epoxycyclohexane carboxylate, lactone-modified epoxidized tetrahydrobenzyl alcohol, and cyclohexene oxide. Furthermore, as the cationic photopolymerizable composition, spiro ortho carbonates may also be used. In the resin composition of the present invention, the cationic photopolymerizable composition can be used usually in an amount of 10% to 90% by mass, and preferably about 50% to 90% by mass.

Examples of commercially available products of the photo-acid generator include UVI-6950, UVI-6970 (bis-[4-(di(4-(2-hydroxyethyl)phenyl)sulfonio)-phenylsulfide]), UVI-6974 (mixture of (bis[4-diphenylsulfonio]-phenyl)sulfide bishexafluoroantimonate and diphenyl-4-thiophenoxyphenylsulfonium hexafluoroantimonate), and UVI-6990 (hexafluorophosphate salt of UVI-6974), which are manufactured by Union Carbide Corporation; Adeka Optomer SP-151, SP-170 (bis[4-(di(4-(2-hydroxyethyl)phenyl)sulfonio)-phenylsulfide]), and SP-150 (hexafluorophosphate of SP-170), which are manufactured by Asahi Denka Co., Ltd.; Irgacure 261 (η5-2,4-cyclopentadien-1-yl) [(1,2,3,4,5,6-η)-(1-methylethyl)benzene]-iron(1+)-hexafluorophosphate(1−)), which is manufactured by Ciba-Geigy Corporation; CI-2481, CI-5102, CI-2855, and CI-2064, which are manufactured by Nippon Soda Co., Ltd.; K185, CD-1010, CD-1011, and CD-1012 (4-(2-hydroxytetradecanyloxy)diphenyliodonium hexafluoroantimonate), which are manufactured by Sartomer Company; DTS-102, DTS-103, NAT-103, NDS-103 ((4-hydroxynaphthyl)-dimethylsulfonium hexafluoroantimonate), TPS-102 (triphenylsulfonium hexafluorophosphate), TPS-103 (triphenylsulfonium hexafluoroantimonate), MDS-103 (4-methoxyphenyl-diphenylsulfonium hexafluoroantimonate), MPI-103 (4-methoxyphenyliodonium hexafluoroantimonate), BBI-101 (bis(4-tert-butylphenyl)iodonium tetrafluoroborate), BBI-102 (bis(4-tert-butylphenyl)iodonium hexafluorophosphate), and BBI-103 (bis(4-tert-phenyl)iodonium hexafluoroantimonate), which are manufactured by Midori Kagaku Co., Ltd.; Degacure K126 (bis[4-(diphenylsulfonio)-phenyl]sulfide bishexafluorophosphate), which is manufactured by Degussa AG; and Rhodosil Photoinitiator 2074 (Trade Name) manufactured by Rhodia Corp. These may be used alone or in combination of two or more.

A second photo-curable resin composition of the present invention includes a radical generator, a dye having an absorption in a range of 760 to 2,000 nm, and a radical photopolymerizable composition. Radical polymerization reaction is initiated by irradiation of near-infrared light to perform curing. In this case, electron transfer occurs between the dye which has absorbed near-infrared light and the radical generator, and thus generation of radicals occurs. With respect to the dye having an absorption in a range of 760 to 2,000 nm, the same dyes as those described above can be used. The dye can be used usually in an amount of 0.1% to 20% by mass, and preferably about 1% to 10% by mass.

As the radical generator (radical photopolymerization initiator), at least one selected from the group consisting of organic peroxides, bisimidazole, iodonium salts, polyhalides, titanocene, boron compounds, sulfonic acid derivatives, and N-phenylglycine is preferably used. In particular, when a boron compound is used together with another radical generator, it is possible to obtain the effect of eliminating light absorption at around 850 nm in the near-infrared range after curing. Among these, examples of the iodonium salts include diphenyliodonium salts, bis(p-chlorophenyl)iodonium salts, ditolyliodonium salts, bis(p-tert-butylphenyl)iodonium salts, and bis(m-nitrophenyl)iodonium salts. Examples of the counter ions therefor include chlorides, bromides, tetrafluoroborates, hexafluorophosphates, and trifluoromethanesulfates. Examples of the boron compounds include tetramethylammonium n-butyltriphenyl borate, tetramethylammonium n-butyltrianisyl borate, tetramethylammonium n-octyltriphenyl borate, tetramethylammonium n-octyltrianisyl borate, tetraethylammonium n-butyltriphenyl borate, tetraethylammonium n-butyltrianisyl borate, trimethylhydrogenammonium n-butyltriphenyl borate, triethylhydrogenammonium n-butyltriphenyl borate, tetrahydrogenammonium n-butyltriphenyl borate, tetrahydrogenammonium tetraphenyl borate, sodium n-butyltriphenyl borate, potassium tetraphenyl borate, sodium n-butyltritolyl borate, tetraethylammonium tetrabutyl borate, tetrabutylammonium n-butyl(triphenysilyl) borate, and tetramethylammonium tri-n-butyl(dimethylphenylsilyl) borate.

Other examples of the radical photopolymerization initiator include acetophenone-based initiators, such as 2-hydroxy-2-methyl-1-phenylpropan-1-one, 1-hydroxycyclohexylphenyl ketone, and 2-methyl-1-(4-(methylthio)phenyl)-2-morpholinopropan-1-one; benzoin-based initiators, such as benzyl dimethyl ketal; benzophenone-based initiators, such as benzophenone, 4-phenylbenzophenone, and hydroxybenzophenone; thioxanthone-based initiators, such as isopropylthioxanthone and 2-4-diethyl thioxanthone; and acylphosphine oxide-based initiators. Furthermore, methylphenyl glyoxylate and other special compounds may also be used. Particularly preferred are 2-hydroxy-2-methyl-1-phenylpropan-1-one, 1-hydroxycyclohexylphenyl ketone, 2-methyl-1-(4-(methylthio)phenyl)-2-morpholinopropan-1-one, benzophenone, and the like. These radical photopolymerization initiators, as necessary, may be used in combination with one or more known photopolymerization accelerators, such as benzoic acid-based photopolymerization accelerators (e.g., 4-dimethylaminobenzoic acid) or tertiary amine-based photopolymerization accelerators. The radical photopolymerization initiators only may be used alone or in combination of two or more. In the resin composition of the present invention, the radical photopolymerization initiator can be used usually 0.1% to 20% by mass, and preferably 1% to 10% by mass.

With respect to the radical photopolymerization initiators, other examples of the acetophenone-based initiators include 4-phenoxydichloroacetophenone, 4-tert-butyl-dichloroacetophenone, 4-tert-butyl-trichloroacetophenone, diethoxyacetophenone, 1-(4-isopropylphenyl)-2-hydroxy-2-methylpropan-1-one, 1-(4-dodecylphenyl)-2-hydroxy-2-methylpropan-1-one, and 4-(2-hydroxyethoxy)-phenyl(2-hydroxy-2-propyl) ketone. Other examples of the benzophenone-based initiators include benzoylbenzoic acid, methyl benzoylbenzoate, 4-benzoyl-4′-methyldiphenyl sulfide, and 3,3′-dimethyl-4-methoxybenzophenone. Examples of the acylphosphine oxide-based initiators include 2,4,6-trimethylbenzoyldiphenylphosphine oxide and bis(2,6-dimethoxybenzoyl)-2,4,4-trimethyl-pentylphosphine oxide.

Among the acetophenone-based initiators described above, 2-hydroxy-2-methyl-1-phenylpropan-1-one, 1-hydroxycyclohexylphenyl ketone, and 2-methyl-1-(4-(methylthio)phenyl)-2-morpholinopropan-1-one are particularly preferred. Among the benzophenone-based initiators described above, benzophenone, benzoylbenzoic acid, and methyl benzoylbenzoate are particularly preferred.

Examples of the tertiary amine-based photopolymerization accelerator that may be used include triethanolamine, methyldiethanolamine, triisopropanolamine, 4,4′-dimethylaminobenzophenone, 4,4′-diethylaminobenzophenone, ethyl 2-dimethylaminobenzoate, ethyl 4-dimethylaminobenzoate, (n-butoxy)ethyl 4-dimethylaminobenzoate, isoamyl 4-dimethylaminobenzoate, and 2-ethylhexyl 4-dimethylaminobenzoate. Particularly preferably, ethyl 4-dimethylaminobenzoate, (n-butoxy)ethyl 4-dimethylaminobenzoate, isoamyl 4-dimethylaminobenzoate, 2-ethylhexyl 4-dimethylaminobenzoate, or the like is used as the photopolymerization accelerator. As described above, the photopolymerization initiators may be used alone or in combination of two or more, or may be used in combination with one or more photopolymerization accelerators.

Furthermore, the radical photopolymerizable composition uses radical polymerization reaction of unsaturated double bonds and is mainly composed of a photopolymerizable functional group-containing monomer or oligomer. As necessary, a reactive polymer may be added to the radical photopolymerizable composition. Furthermore, in order to adjust viscosity, a binder resin may be added to the radical photopolymerizable composition. Any binder resin that can be mixed with a photo-curable resin and that does not have large absorption in the near-infrared range can be used without limitations.

Examples of the photopolymerizable functional group-containing, reactive polymer include homopolymers or copolymers (i.e., acrylic resins) which are obtained from alkyl acrylates (e.g., methyl acrylate, ethyl acrylate, butyl acrylate, and 2-ethylhexyl acrylate) and/or alkyl methacrylates (e.g., methyl methacrylate, ethyl methacrylate, butyl methacrylate, and 2-ethylhexyl methacrylate) and which have a photopolymerizable functional group at their main chains or side chains. For example, such a polymer can be produced by a method in which at least one (meth)acrylate and a (meth)acrylate having a functional group, such as a hydroxyl group (e.g., 2-hydroxyethyl (meth)acrylate) are copolymerized, and the resulting polymer is allowed to react with a compound which reacts with the functional group of the polymer and has a photopolymerizable functional group. Therefore, an acrylic resin which has a photopolymerizable functional group through a urethane bond is preferable.

In the resin composition of the present invention, the radical photopolymerizable composition can be used usually in an amount of 10% to 90% by mass, and preferably about 50% to 90% by mass. In the present invention, preferably, the resin composition contains a radical photopolymerizable composition having at least one ethylenically unsaturated double bond.

As required, the resin composition of the present invention may be incorporated with other additives, such as a solvent, an antioxidant, and a plasticizer, to an extent that does not impair the effect of the present invention.

The resin composition of the present invention is cured by irradiation of near-infrared light. As the light source used for curing in the present invention, any light source that emits near-infrared light can be used without particular limitations. Examples of the light source include semiconductor lasers, laser diodes, light emitting diodes (LED), halogen lamps, and vertical cavity surface emitting laser diodes (VCSEL). Furthermore, after irradiation of near-infrared light, by heating according to need, curing can be accelerated.

The resin composition of the present invention may further include a known ultraviolet-curable resin composition component which is cured by irradiation of ultraviolet light. The ultraviolet-curable resin composition component is not particularly limited. The resin composition of the present invention containing an ultraviolet-curable resin composition component has the feature in that curing can be performed by both near-infrared light and ultraviolet light. In such a case, preferably, the refractive index of the component cured by the irradiation of near-infrared light is higher than the refractive index of the component cured by the irradiation of ultraviolet light. Preferably, the dye is decomposed by the irradiation of ultraviolet light and the absorption in the near-infrared range is thereby decreased.

Furthermore, preferably, the resin composition of the present invention further includes a thermosetting resin composition component that is cured by heating. In such a case, the resin composition of the present invention can be cured either by irradiation of near-infrared light or by heat treatment. In such a case, preferably, the dye is decomposed by heating and the absorption in the near-infrared range is thereby decreased.

In the resin composition of the present invention, by incorporating the ultraviolet-curable resin composition component or the thermosetting resin composition component, for example, after part of the resin composition is cured by irradiation of near-infrared light, it is possible to cure the remaining portion by irradiation of visible light or ultraviolet light or by heating.

Because of the features described above, the photo-curable resin compositions of the present invention can be suitably used for adhesive materials and coating materials. Specifically, the photo-curable resin compositions can be suitably used as materials for optical parts and optical waveguides.

### EXAMPLES

The present invention will be described in detail based on the examples below.

Photo-curable resin compositions were prepared according to the mixing ratios described below.

(Example 1)

| | |
|---|---|
| Pentaerythritol triacrylate | 100 parts by weight |
| 8-[(6,7-Dihydro-2,4-diphenyl-5H-1-benzopyran- | 10 parts by weight |
| 8-yl)methylene]5,6,7,8-tetrahydro-2,4-diphenyl- | |
| 1-benzopyrylium perchlorate | |
| Diphenyliodonium chloride | 3 parts by weight |
| N-phenylglycine | 1 part by weight |

The resulting composition was irradiated for 5 minutes using an 830 nm semiconductor laser (YAG laser), and curing was confirmed.

(Example 2)

| | |
|---|---|
| 8-[(6,7-Dihydro-2,4-diphenyl-5H-1-benzopyran- | 10 parts by weight |
| 8-yl)methylene]5,6,7,8-tetrahydro-2,4-diphenyl- | |
| 1-benzopyrylium perchlorate | |
| Diphenyliodonium chloride | 10 parts by weight |
| IRGACURE-184 (manufactured by Ciba | 3 parts by weight |
| Corporation) | |
| Trimethylolpropane triacrylate | 30 parts by weight |
| Hexanediol diacrylate | 30 parts by weight |
| Diethylene glycol divinyl ether | 50 parts by weight |
| 2-Hydroxyl vinyl ether | 50 parts by weight |

Using a LAX-102•IR mirror module manufactured by Asahi Spectra Co., Ltd., part of the resulting composition was cured by irradiation of near-infrared light from the tip of the fiber light source, and then the whole composition was irradiated with ultraviolet light (UV) to cure the uncured portion and decompose the dye, thus eliminating the absorption at a wavelength of 850 nm.

(Example 3)

| | |
|---|---|
| 8-[(6,7-Dihydro-2,4-diphenyl-5H-1-benzopyran- | 10 parts by weight |
| 8-yl)methylene]5,6,7,8-tetrahydro-2,4-diphenyl-1- | |
| benzopyrylium perchlorate | |
| Diphenyliodonium chloride | 10 parts by weight |
| Azobisisobutyronitrile | 3 parts by weight |
| Trimethylolpropane triacrylate | 30 parts by weight |
| Hexanediol diacrylate | 30 parts by weight |
| Diethylene glycol divinyl ether | 50 parts by weight |
| 2-Hydroxyl vinyl ether | 50 parts by weight |

Using a LAX-102•IR mirror module manufactured by Asahi Spectra Co., Ltd., part of the resulting composition was cured by irradiation of near-infrared light from the tip of the fiber light source. Subsequently, heating was performed at 120° C. to cure the uncured portion and decompose the dye, thus eliminating the absorption at a wavelength of 850 nm.

What is claimed is:

1. A photo-curable resin composition comprising:
a photo-acid generator;
a dye having an absorption in a range of 760 to 2,000 nm; and
a cationic photopolymerizable composition,
wherein the photo-acid generator generates an acid by irradiation of near-infrared light to initiate cationic polymerization reaction for curing.

2. The photo-curable resin composition according to claim 1, wherein the photo-acid generator generates a Broensted acid or a Lewis acid by the irradiation of near-infrared light.

3. The photo-curable resin composition according to claim 1, wherein the photo-acid generator is at least one selected from the group consisting of aryldiazonium salts, diaryliodonium salts, triarylsulfonium salts, dialkylphenacylsulfonium salts, and sulfonic ester compounds.

4. The photo-curable resin composition according to claim 1, further comprising an ultraviolet-curable resin composition component which is cured by irradiation of ultraviolet light.

5. The photo-curable resin composition according to claim 4, wherein the refractive index of the component cured by the irradiation of near-infrared light is higher than the refractive index of the component cured by the irradiation of ultraviolet light.

6. The photo-curable resin composition according to claim 4, wherein the dye is decomposed by the irradiation of ultraviolet light and the absorption in the near-infrared range is thereby decreased.

7. The photo-curable resin composition according to claim 1, further comprising a thermosetting resin composition component that is cured by heating.

8. A photo-curable resin composition comprising:
a radical generator;
a dye having an absorption in a range of 760 to 2,000 nm; and
a radical photopolymerizable composition,
wherein radical polymerization reaction is initiated by irradiation of near-infrared light to perform curing.

9. The photo-curable resin composition according to claim 8, wherein the radical generator is at least one selected from the group consisting of organic peroxides, bisimidazole, iodonium salts, polyhalides, titanocene, boron compounds, sulfonic acid derivatives, and N-phenylglycine.

10. The photo-curable resin composition according to claim 8, wherein the photo-curable resin composition includes a radical polymerizable compound containing at least one ethylenically unsaturated double bond.

11. The photo-curable resin composition according to claim 8, further comprising an ultraviolet-curable resin composition component which is cured by irradiation of ultraviolet light.

12. The photo-curable resin composition according to claim 11, wherein the refractive index of the component cured by the irradiation of near-infrared light is higher than the refractive index of the component cured by the irradiation of ultraviolet light.

13. The photo-curable resin composition according to claim 11, wherein the dye is decomposed by the irradiation of ultraviolet light and the absorption in the near-infrared range is thereby decreased.

14. The photo-curable resin composition according to claim 8, further comprising a thermosetting resin composition component that is cured by heating.

15. An optical part comprising the photo-curable resin composition according to claim 1.

16. An optical part comprising the photo-curable resin composition according to claim 8.

17. An optical waveguide comprising the photo-curable resin composition according to claim 1.

18. An optical waveguide comprising the photo-curable resin composition according to claim 8.
